(19) United States
(12) Patent Application Publication
(10) Pub. No.: US 2015/0142560 A1
(43) Pub. Date: May 21, 2015

(54) Content Delivery Based on Monitoring Mobile Device Usage

(71) Applicant: Tarandeep Singh, Ghaziabad (IN)

(72) Inventor: Tarandeep Singh, Ghaziabad (IN)

(73) Assignee: Google Inc., Mountain View, CA (US)

(21) Appl. No.: 13/492,409

(22) Filed: Jun. 8, 2012

(51) Int. Cl. G06Q 30/02; H04W 4/02

(52) U.S. Cl. CPC G06Q 30/0267; G06Q 30/0255; G06Q 30/0261; G06Q 30/0269
USPC 705/14.53; 705/14.58

(57) ABSTRACT

This specification describes methods, systems, and apparatus, including computer programs encoded on a computer-readable storage device, for providing a content item. The subject matter of the specification is embodied in a method that includes receiving, from a mobile device, data representing location and usage pattern information pertaining to the mobile device. The usage pattern information includes information relating to usage of applications deployed on the mobile device. The method further includes updating, based on the received data, an interest profile that represents preferences of a user of the mobile device, and selecting a content item from an available pool of content items such that the selected content item is related to at least one preference represented in the interest profile. The method also includes delivering the content item to the mobile device.

### BACKGROUND

This specification relates to information presentation.

Sponsored content (e.g. advertisements, promotions, informational materials and the like) can be provided over the Internet to various user devices such as smartphones. For example, a web page can include slots in which sponsored content can be presented. These slots can be defined in the web page or defined for presentation with a web page, for example, along with search results or other content. Sponsored content can also be delivered through dedicated web portals or applications executing on a user device.

### SUMMARY

In general, in one aspect, a method includes receiving, from a mobile device, data representing location and usage pattern information pertaining to the mobile device. The usage pattern information includes information relating to usage of applications deployed on the mobile device. The method further includes updating, based on the received data, an interest profile that represents preferences of a user of the mobile device, and selecting a content item from an available pool of content items such that the selected content item is related to at least one preference represented in the interest profile. The method also includes delivering the content item to the mobile device.

In another aspect, a system includes a content management and delivery system. The content management and delivery system is configured to receive, from a mobile device, data representing location and usage pattern information pertaining to the mobile device wherein the usage pattern information includes information relating to usage of applications deployed on the mobile device. The content management and delivery system is further configured to update, based on the received data, an interest profile stored in a profile repository, wherein the interest profile represents preferences of a user of the mobile device. The content management and delivery system is also configured to select a content item from an available pool of content items such that the selected content item is related to at least one preference represented in the interest profile, and deliver the content item to the mobile device.

In another aspect, a computer readable storage device has encoded thereon computer readable instructions. The instructions, when executed by a processor, cause a processor to perform operations that include receiving, from a mobile device, data representing location and usage pattern information pertaining to the mobile device. The usage pattern information includes information relating to usage of applications deployed on the mobile device. The operations further include updating, based on the received data, an interest profile that represents preferences of a user of the mobile device, and selecting a content item from an available pool of content items such that the selected content item is related to at least one preference represented in the interest profile. The operations also include delivering the content item to the mobile device.

Implementations may include one or more of the following.

The data representing usage pattern can include information on one or more of phone usage, data usage and text message usage. An indication of an amount of time that a user spends at each of a plurality of locations can be received and the interest profile can be updated based on the indication. The amount of time can be determined. One or more frequently visited geographical locations can be determined and the interest profile can be updated based on the determined one or more frequently visited geographical locations. The received data can include network information pertaining to wireless networks available in the one or more frequently visited geographical locations. The content item can be selected based on the network information and the content item can be related to a wireless service available in the one or more frequently visited geographical locations. The interest profile can include information on a profession of the user. The preferences can include information on one or more of shopping and eating habits of the user as determined from the data received from the mobile device. The one or more frequently visited geographical locations can be determined based on receiving latitude and longitude information from the mobile device. Businesses and places of interest corresponding to the latitude and longitude information can be determined. The interest profile can be updated based on the businesses and places of interest. Weights can be assigned to each of the plurality of locations, and the interest profile can be updated based on the assigned weights. The weights can be assigned in accordance with a parameter associated with each of the plurality of locations. The parameter can indicate a quality of signal at the mobile device at a corresponding location. The quality of signal can correspond to one of a global positioning system (GPS) signal, a Wi-Fi signal or a cellular network signal.

Particular implementations may realize none, one or more of the following advantages. User activity associated with a user device can include monitoring applications executing on or accessed through the user device. Sponsored content can be selected for delivery to the user based at least in part on the user activity. An interest profile for a user of a user device can be created and updated based on monitored usage and other information (e.g., location information or application usage information). The interest profile can be evaluated so as to deliver targeted content to the user. Delivery of the targeted content can be made more effective as well as adaptive by automatically updating the interest profile of the user based on monitoring usage of a device of the user.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for delivering content.

FIG. 2 shows an example system for targeted content delivery.

FIG. 3 is a flowchart of an example process for delivering targeted content to users of devices based on interest profiles.

FIG. 4 is a flowchart of an example process for updating an interest profile.

FIG. 5 is a block diagram of an example computer system that can be used to implement the methods, systems and processes described in this disclosure.

Like reference numbers and designations in the various drawings indicate like elements.

### DETAILED DESCRIPTION

This document describes methods, processes, apparatuses and systems for targeting and providing content to users of devices based on monitored usage and other information (e.g., location information provided by the user devices). For example, a particular user's interests and preferences can be determined or estimated based on what applications the user frequently accesses on a corresponding user device. The preferences can be stored in a corresponding interest profile for the user. Similarly, by monitoring geographical location information provided by the user device, locations frequently visited by the user can be determined and the corresponding interest profile can be updated based on the places of interest (e.g., shops, restaurants) near the frequently visited locations. Other parameters related to the various geographic locations (e.g. wireless network strength, quality of signal, or availability of Wi-Fi networks) can also be monitored and the interest profile updated accordingly.

Targeted content can then be delivered to the user device based on the corresponding interest profile of the user. Content sponsors, for example, can target content to users who have specific types of interest profiles. For example, an interest profile for a given user can indicate that the user frequents various restaurants and eats out several times a month, and/or the user uses applications on his or her user device in locating or researching restaurants. Content sponsors promoting or providing offers for restaurants can be interested in having their content delivered to the user device of these particular users. In another example, if an interest profile for a given user indicates that the user frequently uses the camera on his or her user device and also uses photo editing applications, content sponsors promoting photography related equipment can target such content to those users who are determined to be interested in such content (i.e., by their expressed or implied expression of interest).

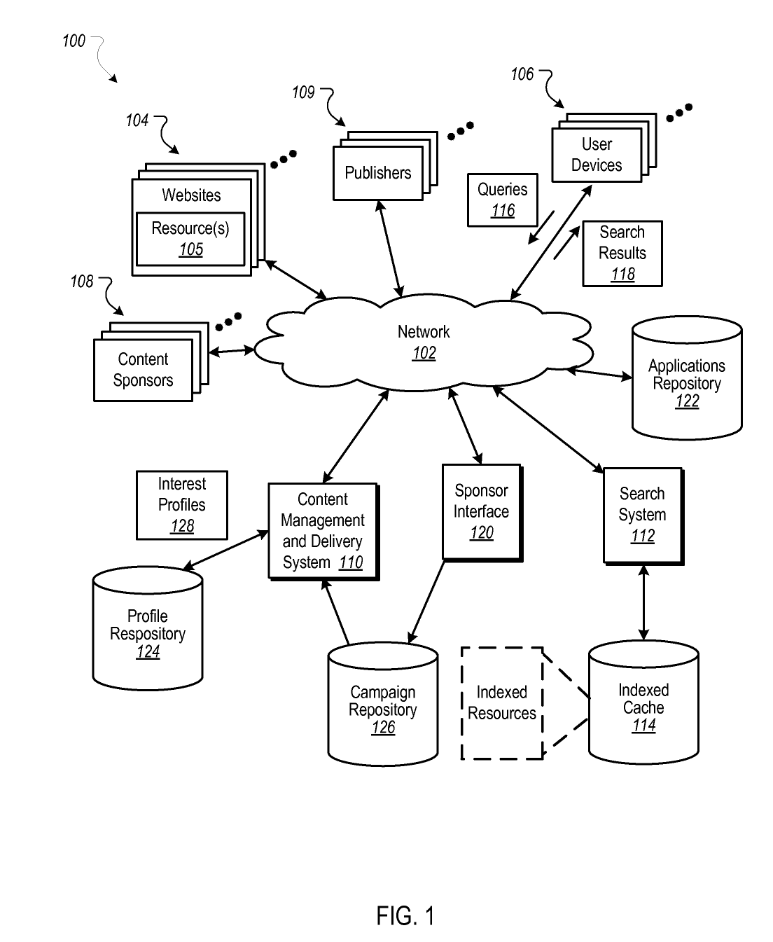

FIG. 1 is a block diagram of an example environment 100 for delivering content. The example environment 100 includes a content management and delivery system 110 for selecting and providing content to user devices. The example environment 100 includes a network 102, such as a local area network (LAN), a wide area network (WAN), the Internet, or a combination thereof. The network 102 connects websites 104, user devices 106, content sponsors 108 (e.g., advertisers), content publishers 109, and the content management and delivery system 110. The example environment 100 may include many thousands of websites 104, user devices 106, content sponsors 108 and content publishers 109.

A campaign repository 126 can store campaigns that are created by content sponsors 108, e.g., using the sponsor interface 120. For example, the campaigns can include targeting criteria specified by content sponsors 108 to target content to users based on their interest profiles 128 as stored in a profile repository 124.

In some implementations, the content management and delivery system 110 includes a request handler that can receive a request for content from a user, identify one or more eligible content items, and provide a content item responsive to the request. More specifically, the request handler can determine, for campaigns that include targeting criteria defined to target users having particular interest profiles 128, if a campaign of a content sponsor 108 is targeted to at least one preference represented in the interest profile 128 of the user. In some implementations, the content management and delivery system 110 can deliver sponsored content to user devices 106 even in the absence of a request for content. For example, the content management and delivery system 110 can be configured to periodically deliver sponsored content (e.g. daily or weekly deals and offers) to user devices 106. In some implementations, the content management and delivery system 110 can also be configured to deliver sponsored content to a user device 106 based on a geographical location of the user device 106. For example, if the user device 106 is carried by the user into a new locality, the content management and delivery system 110 can be configured to deliver local content (e.g. content about most popular local products) or content from local sponsors (e.g. local deals and offers) to the user device 106.

A website 104 includes one or more resources 105 associated with a domain name and hosted by one or more servers. An example website is a collection of web pages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources include HTML pages, word processing documents, portable document format (PDF) documents, images, video, and news feed sources, to name only a few. The resources can include content, such as words, phrases, images, video and sounds, that may include embedded information (such as meta-information hyperlinks) and/or embedded instructions (such as JavaScript scripts). In some implementations, the resources 105 can include sponsored content provided by the content sponsors 108. For example, the resources 105 can include an advertisement, a deal or a special offer sponsored by a content sponsor 108.

A user device 106 is an electronic device that is under control of a user and is capable of requesting and receiving resources over the network 102. Example user devices 106 include personal computers, televisions with one or more processors embedded therein or coupled thereto, set-top boxes, mobile communication devices (e.g., mobile devices such as smartphones, tablet computers, e-readers, laptop computers, personal digital assistants (PDA)), and other devices that can send and receive data over the network 102. A user device 106 typically includes one or more user applications, such as a web browser, to facilitate the sending and receiving of data over the network 102. In some implementations, the user device 106 can be configured to execute applications that are configured to receive/generate/manage sponsored or other content and campaigns from the content management and delivery system 110. In some implementations, such applications can include third-party applications and can be downloaded to the user device 106 from an applications repository 122. Sponsored and/or targeted content can also be delivered to the user devices 106 through a messaging service such as text or multimedia messaging.

A user device 106 can request resources 105 from a website 104. In turn, data representing the resource 105 can be provided to the user device 106 for presentation by the user device 106. The data representing the resource 105 can also include data specifying a portion of the resource or a portion of a user display, such as a presentation location of a pop-up window or a slot of a third-party content site or web page, in which content can be presented. These specified portions of the resource or user display are referred to as slots (e.g., ad slots).

To facilitate searching of these resources, the environment 100 can include a search system 112 that identifies the resources by, for example, crawling and indexing the resources provided by the content publishers on the websites 104. Data about the resources can be indexed based on the resource to which the data corresponds. The indexed and, optionally, cached copies of the resources can be stored in an indexed cache 114.

User devices 106 can submit search queries 116 to the search system 112 over the network 102. In response, the search system 112 accesses the cache 114 or index to identify resources that are relevant to the search query 116. The search system 112 identifies the resources in the form of search results 118 and returns the search results 118 to the user devices 106 in search results pages. A search result 118 is data generated by the search system 112 that identifies a resource that is responsive to a particular search query, and includes a link to the resource. In some implementations, the content management and delivery system 110 can generate search results 118 using information (e.g., identified resources) received from the search system 112. An example search result 118 can include a web page title, a snippet of text or a portion of an image extracted from the web page, and the URL of the web page. Search results pages can also include one or more slots in which other content items (e.g., ads) can be presented. In some implementations, slots on search results pages or other web pages can include content slots for content items that have been provided as part of a reservation process. In a reservation process, a publisher and a content item sponsor enter into an agreement where the publisher agrees to publish a given content item (or campaign) in accordance with a schedule (e.g., provide 1000 impressions by date X) or other publication criteria. In some implementations, content items that are selected to fill the requests for content slots can be selected based, at least in part, on priorities associated with a reservation process (e.g., based on urgency to fulfill a reservation) and information related to roles.

When a resource 105, search results 118 and/or other content are requested by a user device 106, the content management and delivery system 110 receives a request for content. The request for content can include characteristics of the slots that are defined for the requested resource or search results page, and can be provided to the content management and delivery system 110. In some implementations, the content management and delivery system can analyze the content requests from a user device 106 to update an interest profile 128 corresponding to a user of the user device 106. The interest profile 128 can be stored in the profile repository 124 accessible by the content management and delivery system 110.

Based at least in part on the interest profiles 128 stored in the profile repository 124, the content management and delivery system 110 can select content or campaigns that are eligible to be provided to various user devices. For example, the content management and delivery system 110 can choose a content item for a particular user device 106 from the pool of content items available in the campaign repository 126, such that the selected content item is related to at least one preference represented in the corresponding interest profile 128 of the user of the device 106. Eligible content items can include, for example, eligible ads, promotional offers, deals or informational materials or other content having characteristics matching one or more preferences represented in the corresponding interest profile 128.

The content management and delivery system 110 can select from the eligible content items that are to be provided to the user device 106 based at least in part on results of an auction (or by some other selection process). For example, for the eligible content items, the content management and delivery system 110 can receive offers from content sponsors 108 and allocate or prioritize delivery of the content items, based at least in part on the received offers (e.g., based on the highest bidders at the conclusion of the auction or based on other criteria, such as those related to satisfying open reservations). The offers represent the amounts that the content sponsors are willing to pay for delivery (or selection) of their content to a user device 106 either independently or with a resource or search results page. For example, an offer can specify an amount that a content sponsor is willing to pay for each 1000 impressions (i.e., presentations) of the content item, referred to as a CPM bid. Alternatively, the offer can specify an amount that the content sponsor is willing to pay for a selection (i.e., a click-through) of the content item or a conversion following selection of the content item. For example, the selected content item can be determined based on the offers alone, or based on the offers of each content sponsor being multiplied by one or more factors, such as quality scores derived from content performance, landing page scores, and/or other factors.

A conversion can be said to occur when a user performs a particular transaction or action related to a content item provided with a resource or search results page. What constitutes a conversion may vary from case-to-case and can be determined in a variety of ways. For example, a conversion may occur when a user clicks on a content item (e.g., an ad), is referred to a web page, and consummates a purchase there before leaving that web page. A conversion can also be defined by a content provider to be any measurable/observable user action, such as downloading a white paper, navigating to at least a given depth of a website, viewing at least a certain number of web pages, spending at least a predetermined amount of time on a web site or web page, registering on a website, experiencing media, or performing a social action regarding a content item (e.g., an ad), such as republishing or sharing the content item. Other actions that constitute a conversion can also be used.

In some implementations, the likelihood that a conversion will occur can be improved, such as by delivering content that is more likely to be of interest to the user. For example, content items (e.g., ads, special offers or daily deals) that are delivered to a user device 106 can be selected in part based on user preferences represented in corresponding interest profiles 128, which can also be an indication of how likely the user is to react positively to a content item, e.g., leading to a conversion.

An interest profile 128 stored in the profile repository 124 represents personal preferences of a corresponding user and can be created and updated based on monitoring usage and other information related to the device. For example, the content management and delivery system 110 can receive geographical location information from the user device and determine which geographical locations are frequently visited by the user. For example, if the user frequently visits electronics stores, the corresponding interest profile 128 for the user can be updated to indicate that the user appears to have more than just a passing interest in electronic devices. The geographical locations received from the user device 106 can also be used to determine which merchants, businesses or restaurants are frequented by the user and the corresponding interest profile 128 can be updated accordingly. The interest profile 128 can also be updated based on monitoring application usage on the user device 106. In some implementations, the interest profile 128 can be updated based on monitoring the nature of third party applications downloaded and used by the user on the user device 106. For example, if the user frequently downloads photography related applications from the applications repository 122 and uses them on the user device 106, the corresponding interest profile can be updated to indicate preferences for photography and images. In another example, if a user buys or checks availability of movie tickets, or reads movie reviews using one or more applications, the interest profile can be updated to indicate an interest in movies or particular genres of media.

The interest profile 128 can also be updated by monitoring one or more of browser history, search history, etc. and combining such information with the geographical location information and/or application usage information for additional contextualization. For example, a user may use social networking applications and shopping sites mostly during the evenings while searching only for work related issues during the day. In such cases, the interest profile can be updated to reflect that the user probably does not indulge in casual browsing while at work. Accordingly, the content management and delivery system 110 can deliver targeted content at a time when the user is more likely to view/want to interact with the delivered content.

The interest profile 128 can also be updated with network information corresponding to the various geographical locations. The network information (e.g. signal strength, quality, availability of alternative networks such as Wi-Fi, etc.) can be used to assign weights to information received from the corresponding locations. For example, if the cellular signal strength is low or unreliable and no usable Wi-Fi network is available, the received location information may include a parameter that indicates a potentially low reliability. The information in the interest profile 128 related to such low reliability location information can then be assigned a low weight in determining the preferences of the user. On the other hand, for locations with high signal strength, the information in the interest profile 128 is assigned high weights in determining the preferences of the user.

The interest profile 128 can also be manually edited by a user to add, delete or otherwise edit the preferences. For example, the user may be able to view the corresponding interest profile 128 through a user interface and edit the interest profile for improved accuracy. In some implementations, the user can also choose to have the content management and delivery system 110 override (e.g., for one occurrence or for a proscribed time period) the interest profile 128 in delivering content to the user device 106. This can be useful in situations, for example, where the user is interested in expanding his/her horizons and is looking to receive content in areas beyond his current set of preferences.

For situations in which the systems discussed here collect personal information about users, the users may be provided with an opportunity to opt in/out of programs or features that may collect personal information (e.g., information about a user's social network, social actions or activities, profession, a user's preferences, or a user's current location). In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (such as to a city, ZIP code, or state level), so that a particular location of a user cannot be determined. In some implementations, users can opt out of being characterized or targeted for content, including advertisements, based on the interest profiles for which they may be characterized.

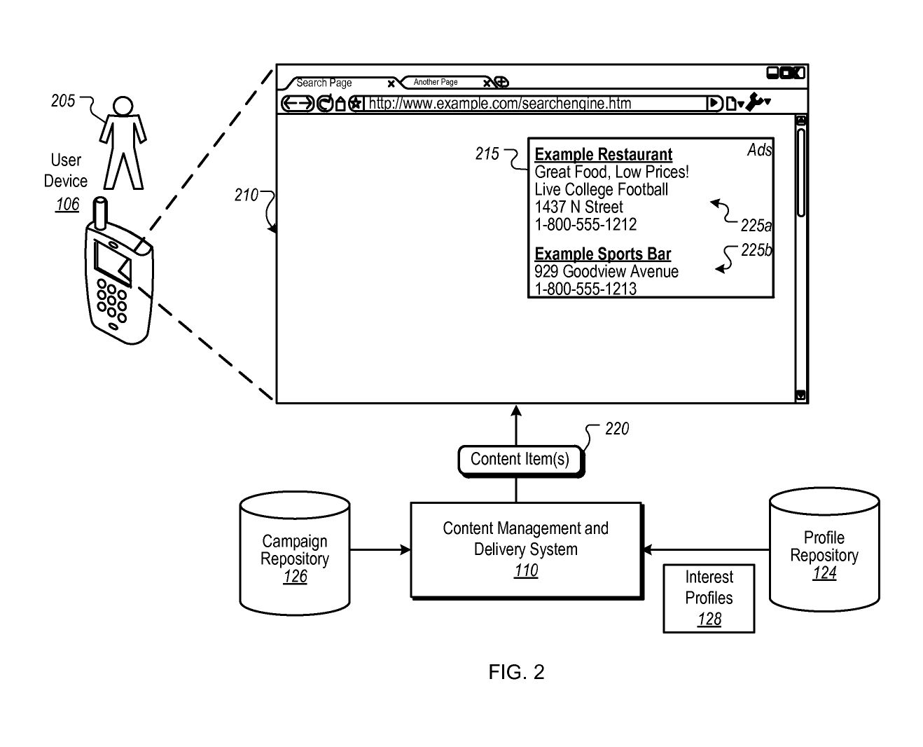

FIG. 2 shows an example user interface 210 in which targeted content is provided based on an interest profile of a user 205. For example, the content management and delivery system 110 can provide content (e.g., advertisements, offers, etc.) from the pool of available content items, for example, in the campaign repository 126). Such targeted content delivery can be initiated in response to received requests to deliver content to the user interface. In some implementations, the content can be delivered to the user device 106 (e.g. randomly, periodically, or based on a location) without receiving a request for content delivery. Even though the example in FIG. 2 describes content delivery through a portion of a browser, in general, the user interface can be a part of a stand-alone application (e.g., a third-party application for delivering targeted offers), a text message, a multimedia message, an e-mail or other message format.

In some implementations, the user interface 210 can be, for example, associated with a social networking web page or some other resource (e.g., a resource displayed in a web browser) that is presented to a user 205 on the user device 106. The user interface 210 can include one or more content item slots 215, e.g., for displaying content such as advertisements or offers on the web page. To fill the content item slots 215, for example, a request for content can be provided by the user device 106 to the content management and delivery system 110. Upon receipt of the request for content, the content management and delivery system 110 can provide content items 220 that are responsive to the request, as described above. In some implementations, the content items 220 can be provided in the absence of a request for content. For example, if a characteristic of the content item matches a preference of the user 205 as stored in a corresponding interest profile 128 in the profile repository 124, the content items 220 can be delivered to the user device 106. In general, the content items 220 that are provided to the user device 106 can be selected from the campaign repository 126 based on an interest profile 128 with which the user 205 is associated.

In some implementations, the interest profile 128 associated with the user 205 can, for example, represent multiple preferences of the user. The content management and delivery system 110 can access information in the campaign repository 126 to identify content items that match at least one preference represented in the interest profile 128 and have the content items delivered to the user device 106 of the user 205. In some implementations, if multiple eligible content items are available, the content management and delivery system 110 can be configured to prioritize delivery based at least in part on parameters available in or derived from the information in the interest profile 128. The parameters can indicate, for example, a degree of preference of the user 205 for various preferences stored in the interest profile 128. In some implementations, the eligible content items from the campaign repository 126 can be ranked using the parameters from the interest profile 128 associated with a given user (e.g., user 205). The ranking of the eligible content items can change, for example, from one week to another, one day to another, one geographical location to another, or from one time of the day to another. For example, if the interest profile 128 corresponding to a given user 205 indicates that the user in interested in restaurants as well as watching college football, then content such as the advertisements 225a (restaurant that shows live college football) and 225b (a sports bar) can be delivered to the user device 106 on a college football game day. On another day when there is no game scheduled, the delivered content may include restaurants that do not show games.

In some implementations, the one or more content items 220 that are selected can be selected by conducting an auction. For example, the auction can include one or more bids associated with the content sponsors 108 that elected to target users 205 having a specific interest. As a result, the content items 220 that are provided can be based at least in part on the auction and the information in the interest profiles 128, as well as other information, e.g., including the relevance of content items to a time of the day, geographical location, keywords, or content item request, to name a few examples.

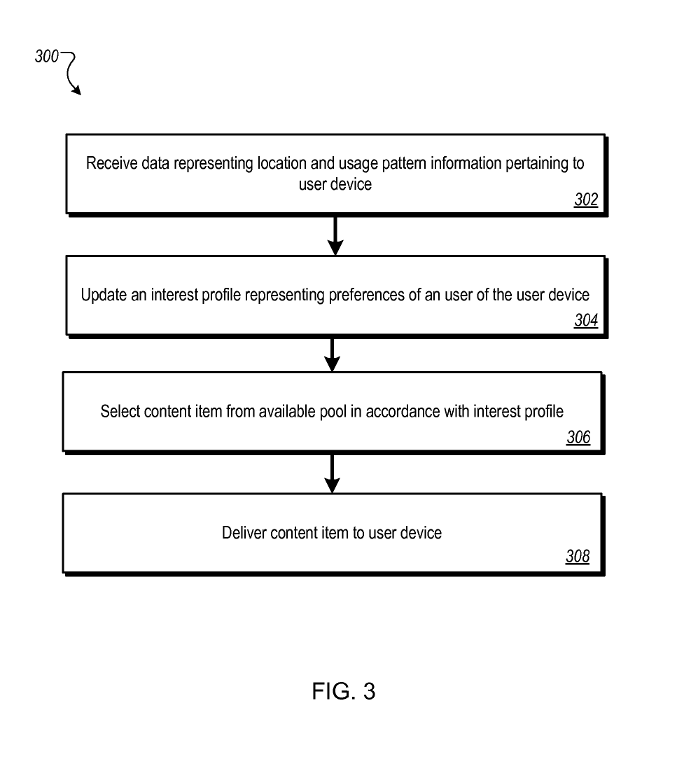

FIG. 3 is a flowchart of an example process 300 for delivering targeted content based on interest profiles. The process 300 can be performed by the content management and delivery system 110, for example, using the campaign repository 126 and the sponsor interface 120. FIGS. 1 and 2 are used to provide examples for steps of the process 300.

Operations of the process can include receiving data representing location and usage pattern information pertaining to a user device (302). The data can be received at one or more servers within or associated with the content management and delivery system 110 described above with reference to FIG. 1. The location information can include, for example, geographical locations visited by the user of the user device, frequency of visiting particular locations, time of visiting particular locations, and time spent at particular locations. The usage pattern information can include information relating to usage of applications deployed on the user device including usage of applications at specific locations. For example, the usage pattern information can include information on applications accessed on the user device, time of access for particular applications, geographical locations where the particular applications are accessed, types of the particular applications and information accessed using the particular applications. The usage information can also include, for example, phone and message usage, search history, browsing history, and voice and data signal quality at various locations pertaining to the user device.

An interest profile representing preferences of the user device user is updated (304). The interest profile is updated based on the data received from the user device. In some implementations, if a corresponding interest profile is not found, updating an interest profile can include setting up an interest profile corresponding to the user device and/or the user of the user device. This can happen, for example, when the user has acquired a new user device. The interest profile 128 can be identified at the content management and delivery system 110 by an identifier that uniquely identifies the user device or the user of the user device.

A content item is selected from an available pool of content items in accordance with the interest profile (306). The content item is selected such that the selected content item is related to at least one preference of the user represented in the corresponding interest profile. For example, if a particular interest profile indicates that a user frequently accesses game based applications on the user device, the content management and delivery system 110 can accordingly select the content items, such as, an advertisement for a gaming console, or an offer from a local computer game seller. In some implementations, selecting a content item can also include excluding certain content items from the available pool. For example, if a particular interest profile indicates that the corresponding user frequently uses applications for blood sugar tracking, the content management and delivery system may exclude content items such as offers or advertisements related to candies and pastries from being selected.

Selecting the content item can also be based on matching interest profiles with one or more criteria specified by content sponsors. In some implementations, a content sponsor 108 can use the sponsor interface 120 or other interfaces to target content to users having specific interest profiles. For example, to target content related to sports-related subject matter, a content sponsor 108 can request the content management and delivery system 110 to have corresponding content delivered only to user devices for which the user interest profiles indicate an interest in sports.

The selected content item is delivered to the user device (308). In some implementations, the selected content item can include sponsored content such as an offer, deal or coupon. In some implementations, the selected content item can be an advertisement. The content item can be delivered in response to a user request (for example, as an advertisement served with search results requested by a user) or in the absence of a specific user request. The content item can be delivered, for example, through one or more of a browser, an e-mail, a text message, a multimedia message, an instant message, a voicemail message or a stand-alone application for receiving offers, deals or coupons.

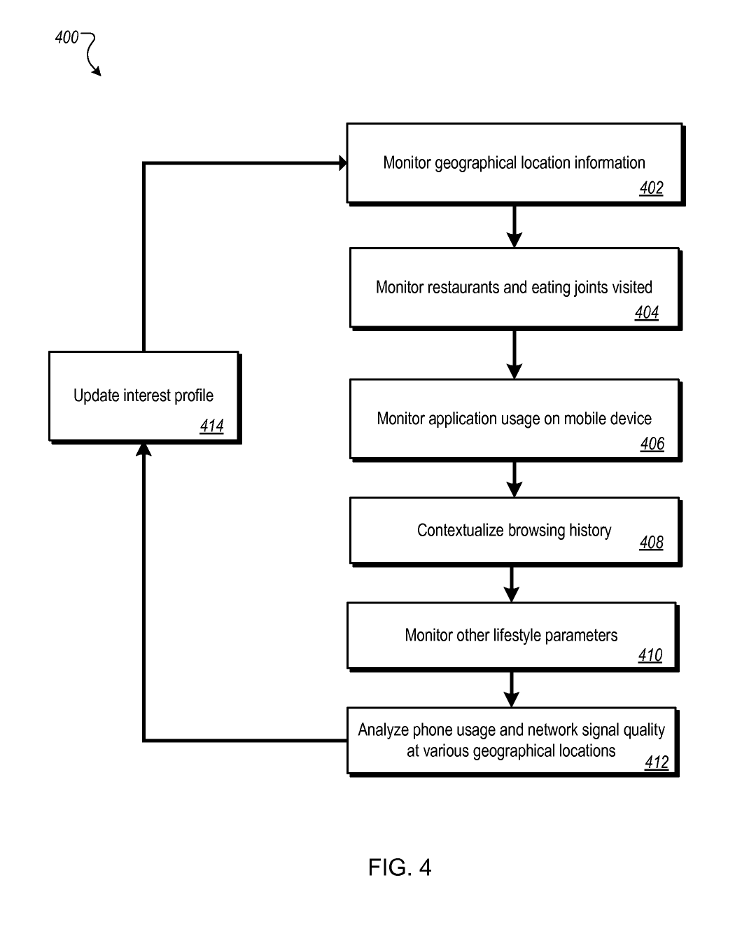

FIG. 4 is a flowchart of an example process 400 for updating an interest profile. The process 400 can be performed by the content management and delivery system 110, for example, in communication with the user device 106.

Operations of the process can include monitoring geographical location information of a user device (402). In some implementations, a location manager module of a user device can retrieve the user's latitude and longitude and forward the information to the content management and delivery system 110. The location information can be used, for example, in conjunction with a map database to return places and attractions substantially near a given location.

In some implementations, the location information can be transmitted intermittently, for example, every few minutes, to reduce battery usage. The frequency of location information transmission can be made configurable based on user input or automatically based on, for example, battery life remaining Between consecutive location information transmissions, if the user is found to be substantially in the vicinity of a same location, the time spent at the location or sub-locations within the location can be separately monitored. For example, to get more accurate location information, indoor maps/navigation can be used. This can provide more granular information about the user's location, for example, in which section of a particular store the user spends the most time. If, for example, the user is determined to be visiting a TV shop, or TV sections in various electronics or departmental stores, the corresponding interest profile can be updated to indicate that the user is likely looking for a new TV.

In some implementations, the location information received from user devices can be ranked based on confidence. For example, if the accuracy of a received location is determined to be low (for example, due to bad GPS signal, triangulation, and/or no Wi-Fi), the user's location can be marked as low-confidence. In such cases, the user's location can be saved as an approximate location. If the user is determined to roam around in substantially the same vicinity, in some implementations, an application on the user device can be configured to trigger real-time location tracking (for at least a limited time) to determine if a Wi-Fi signal or stronger GPS signal is available in the vicinity. If an accurate location is found, even for a short time period, the location information can be upgraded to a high-confidence status. This can happen, for example, if the user is inside a shopping mall, with no Wi-Fi and low GPS signal, and the location information received from the user device is flagged as low-confidence. However, when the user steps out of the mall, the location information can be upgraded to high-confidence based on, for example, the availability of a strong signal outside.

In some implementations, some high-confidence location information can be flagged as uncertain or ambiguous. This can happen, for example, when locations (e.g. two restaurants) are close to each other and available GPS accuracy does not allow additional disambiguation. In another example, locations that are in different floors of a same building can be flagged as ambiguous. In such cases, the real-time location tracking application can be used for further disambiguation, for example, via connecting to a Wi-Fi network. If further disambiguation is not possible, one of the ambiguous locations can be chosen based on, for example, the corresponding interest profile.

Restaurants, businesses or merchants visited (404) by the user can be identified, with such information being used to update the corresponding interest profile with, for example, eating habits and preferences of the user. Monitoring the geographical location information can also include, for example, monitoring landing pages through related searches or applications, monitoring recipe searches to determine culinary preferences, and monitoring calls made to businesses (e.g., restaurants). In some implementations, related time information can also be evaluated and stored in the interest profile. For example, if a particular interest profile indicates that the user often orders late night take-outs, advertisements and offers from late night places can be delivered in accordance with the interest profile.

Application usage on the user device can be monitored (406). In some implementations, a native application programming interface (API) of a mobile operating system can be used to determine recently used applications. A snapshot of a predetermined number of recent applications can be provided by the user device every few minutes and the interest profile can be updated with the applications the corresponding user is most interested in. Data can then be aggregated to determine the most frequently used applications and corresponding durations of use.

In some implementations, the user's interactions with the application repository 122 (described with referenced to FIG. 1) can be evaluated and used to update a respective interest profile. For example, the applications that the user downloads from the applications repository 122 can be recalled and applications' categories can be contextualized based on the metadata available as part of the description or tags, related to the applications. Contextual interpretations can be made using meta-learning algorithms used by applications such as META-WEB.

Browsing history on the user device can be contextualized (408). Contextualization can include evaluating search histories, browsing histories and mobile search histories. Mobile searches or searches originating from a user device can indicate what kind of information a user is usually seeking while on the move. For example, if the user typically searches for a particular topic, such as travel or entertainment (movie shows), more than other topics from a user device, the corresponding interest profile can be updated to indicate that preference.

Other lifestyle parameters can be evaluated (410) such as the user's occupation. For example, a location a user is at during normal working hours and other express or inferred information (e.g., from the business places, buildings etc. that are around the location) can be used to determine/infer a user's occupation. Other lifestyle parameters that can be evaluated can include, for example, commuting habits, usual commuting routes, commute times, sleeping pattern (for example by monitoring appropriate third party applications), work days, and vacation patterns.

Phone usage and network signal quality can be analyzed at various geographical locations (412). For example, the user's data usage habits can be analyzed to determine how much and on what applications data is used. The corresponding interest profile can be updated based on the data usage pattern content items such as deals or suggestions on potentially more appropriate data plans can be delivered to the user device. Similarly, if the user makes several international and/or long distance calls per day, suitable voice plans can be suggested based on the phone usage pattern as reflected in the corresponding interest profile. In one example, if the user frequently travels abroad, the interest profile can be updated to reflect the locations frequently traveled to and a suitable roaming plan can be suggested accordingly. In some implementations, if the user experiences bad signal at one or more frequently visited locations (indicated, for example, by signal level at various points or by identifying that the user is facing call drops), the interest profile can be updated accordingly. The information from the interest profile can be used to suggest, for example, alternative network providers, based on unified data about network coverage in the frequently visited locations.

A corresponding interest profile is updated (414) based on the evaluated/analyzed data. In some implementations, the updating can be done substantially continuously as new information becomes available. In some implementations, the updating is done at predetermined intervals, for example, once every day or every week. The content management and delivery system delivers content items to a user device in accordance with the updated interest profile.

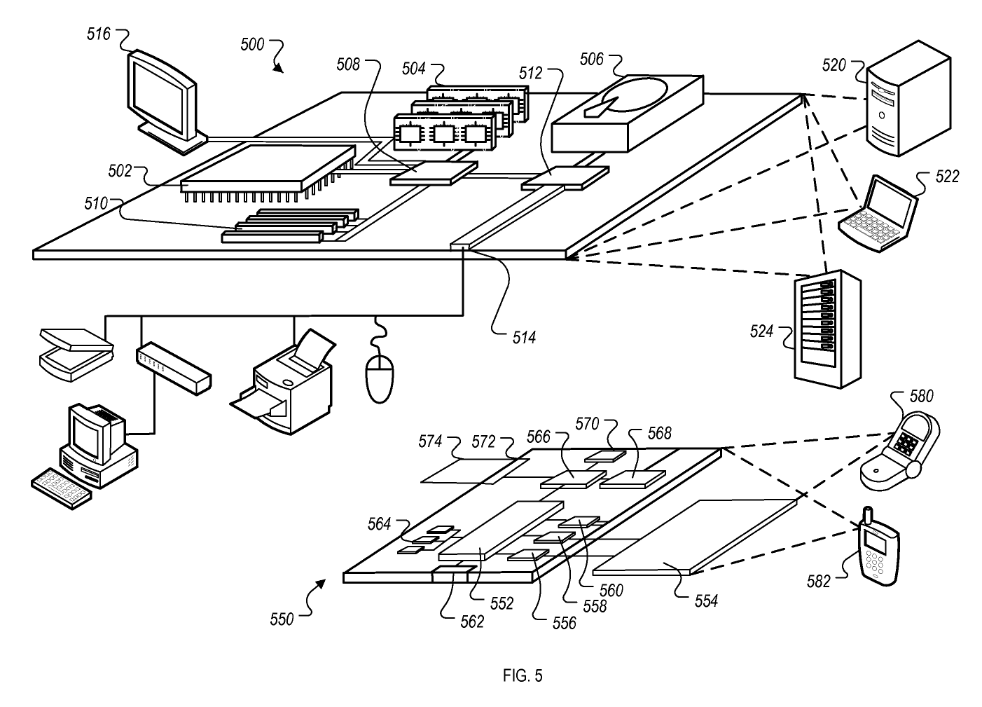

FIG. 5 is a block diagram of computing devices 500, 550 that may be used to implement the systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers. Computing device 500 is further intended to represent various typically non-mobile devices, such as televisions or other electronic devices with one or more processers embedded therein or attached thereto. Computing device 550 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a computer-readable medium. In one implementation, the memory 504 is a volatile memory unit or units. In another implementation, the memory 504 is a non-volatile memory unit or units.

The storage device 506 is capable of providing mass storage for the computing device 500. In one implementation, the storage device 506 is a computer-readable medium. In various different implementations, the storage device 506 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of duties is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can process instructions for execution within the computing device 550, including instructions stored in the memory 564. The processor may also include separate analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD display or an OLED display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provided in communication with processor 552, so as to enable near area communication of device 550 with other devices. External interface 562 may provide, for example, for wired communication (e.g., via a docking procedure) or for wireless communication (e.g., via Bluetooth or other such technologies).

The memory 564 stores information within the computing device 550. In one implementation, the memory 564 is a computer-readable medium. In one implementation, the memory 564 is a volatile memory unit or units. In another implementation, the memory 564 is a non-volatile memory unit or units. Expansion memory 574 may also be provided and connected to device 550 through expansion interface 572, which may include, for example, a single in-line memory module (SIMM) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552.

Device 450 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, GPRS, HSDPA, or LTE among others. Such communication may occur, for example, through radio-frequency transceiver 568. In addition, short-range communication may occur, such as using a Bluetooth, WiFi, or other such transceiver (not shown). In addition, GPS receiver module 570 may provide additional wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving, from a mobile device, data representing a first location, and usage pattern information pertaining to the mobile device, wherein the usage pattern information includes information relating to usage of applications deployed on the mobile device, wherein the information relating to the usage of applications includes a list of applications used at the first location and corresponding durations of use of the applications;
updating, based on the received data, an interest profile that represents preferences of a user of the mobile device;
selecting a content item from an available pool of content items such that the selected content item is related to at least one preference represented in the interest profile, and wherein the selected content item is associated with a second location substantially similar to the first location; and
delivering the selected content item to the mobile device when the mobile device is at the second location.

2. The method of claim 1, wherein the data representing usage pattern further includes information on one or more of phone usage, data usage and text message usage.

3. The method of claim 1 further comprising receiving an indication of an amount of time that a user spends at each of a plurality of locations and updating the interest profile based on the indication.

4. The method of claim 3 further comprising determining the amount of time.

5. The method of claim 1, further comprising determining one or more frequently visited geographical locations and updating the interest profile based on the determined one or more frequently visited geographical locations.

6. The method of claim 5, wherein the received data includes network information pertaining to wireless networks available in the one or more frequently visited geographical locations.

7. The method of claim 6, wherein the content item is selected based on the network information and the content item is related to a wireless service available in the one or more frequently visited geographical locations.

8. The method of claim 1, wherein the interest profile includes information on a profession of the user.

9. The method of claim 1, wherein the preferences include information on one or more of shopping and eating habits of the user as determined from the data received from the mobile device.

10. The method of claim 5, wherein determining the one or more frequently visited geographical locations is based on receiving latitude and longitude information from the mobile device.

11. The method of claim 10, further comprising determining businesses and places of interest corresponding to the latitude and longitude information.

12. The method of claim 11, wherein the interest profile is updated based on the businesses and places of interest.

13. The method of claim 3, further comprising assigning a confidence rating to each of the plurality of locations, and assigning weights to corresponding usage pattern information based on the assigned confidence ratings.

14. The method of claim 13, wherein the weights are assigned in accordance with a parameter associated with each of the plurality of locations.

15. The method of claim 14, wherein the parameter indicates a quality of signal at the mobile device at a corresponding location.

16. The method of claim 15, wherein the quality of signal corresponds to one of a global positioning system (GPS) signal, a Wi-Fi signal or a cellular network signal.

17. A system comprising:
a content management and delivery system configured to:
receive, from a mobile device, data representing location and usage pattern information pertaining to the mobile device wherein the usage pattern information includes information relating to usage of applications deployed on the mobile device, wherein the information relating to the usage of applications includes a list of applications used at the location and corresponding durations of use of the applications,
update, based on the received data, an interest profile stored in a profile repository, the interest profile representing preferences of a user of the mobile device,
select a content item from an available pool of content items such that the selected content item is related to at least one preference represented in the interest profile, and wherein the selected content item is associated with a second location substantially similar to the first location; and
deliver the selected content item to the mobile device when the mobile device is at the second location.

18. The system of claim 17, wherein the data representing usage pattern further includes information on one or more of phone usage, data usage and text message usage.

19. The system of claim 17 wherein the content management and delivery system is configured to receive an indication of an amount of time that a user spends at each of a plurality of locations and update the interest profile based on the indication.

20. The system of claim 199 wherein the content management and delivery system is configured to determine the amount of time.

21. The system of claim 17, wherein the content management and delivery system is configured to determine one or more frequently visited geographical locations and update the interest profile based on the determined one or more frequently visited geographical locations.

22. The system of claim 21, wherein the content management and delivery system is configured to receive network information pertaining to wireless networks available in the one or more frequently visited geographical locations.

23. The system of claim 22, wherein the content management and delivery system is configured to select the content item based on the network information and the content item is related to a wireless service available in the one or more frequently visited geographical locations.

24. The system of claim 17, wherein the preferences include information on one or more of shopping and eating habits of the user as determined from the data received from the mobile device.

25. The system of claim 21, wherein the content management and delivery system is configured to determine the one or more frequently visited geographical locations based on receiving latitude and longitude information from the mobile device.

26. The system of claim 25, wherein the content management and delivery system is configured to determine businesses and places of interest corresponding to the latitude and longitude information.

27. The system of claim 26, wherein the interest profile is updated based on the businesses and places of interest.

28. The system of claim 19, wherein the content management and delivery system is configured to assign a confidence rating to each of the plurality of locations, and assign weights to corresponding usage pattern information based on the assigned confidence ratings.

29. The system of claim 28, wherein the weights are assigned in accordance with a parameter associated with each of the plurality of locations.

30. The system of claim 29, wherein the parameter indicates a quality of signal at the mobile device at a corresponding location.

31. The system of claim 30, wherein the quality of signal corresponds to one of a global positioning system (GPS) signal, a Wi-Fi signal or a cellular network signal.

32. A computer readable storage device having encoded thereon computer readable instructions, which when executed by a processor, cause a processor to perform operations comprising:
receiving, from a mobile device, data representing location and usage pattern information pertaining to the mobile device wherein the usage pattern information includes information relating to usage of applications deployed on the mobile device, wherein the information relating to the usage of applications includes a list of applications used at the location and corresponding durations of use of the applications;
updating, based on the received data, an interest profile that represents preferences of a user of the mobile device;
selecting a content item from an available pool of content items such that the selected content item is related to at least one preference represented in the interest profile, and wherein the selected content item is associated with a second location substantially similar to the first location; and
delivering the selected content item to the mobile device when the mobile device is at the second location.

33. The computer readable storage device of claim 32, wherein the data representing usage pattern further includes information on one or more of phone usage, data usage and text message usage.

34. The computer readable storage device of claim 32, wherein the operations comprise receiving an indication of an amount of time that a user spends at each of a plurality of locations and updating the interest profile based on the indication.

35. The computer readable storage device of claim 32, further comprising determining one or more frequently visited geographical locations and updating the interest profile based on the determined one or more frequently visited geographical locations.

36. The computer readable storage device of claim 32, wherein the preferences include information on one or more of shopping and eating habits of the user as determined from the data received from the mobile device.

37. The computer readable storage device of claim 34, wherein the operations further comprise assigning a confidence rating to each of the plurality of locations, and assigning weights to corresponding usage pattern information based on the assigned confidence ratings.

38. The computer readable storage device of claim 37, wherein the weights are assigned in accordance with a parameter associated with each of the plurality of locations.

39. The computer readable storage device of claim 38, wherein the parameter indicates a quality of signal at the mobile device at a corresponding location.

40. The computer readable storage device of claim 39, wherein the quality of signal corresponds to one of a global positioning system (GPS) signal, a Wi-Fi signal or a cellular network signal.
